(19) United States
(12) Patent Application Publication
(10) Pub. No.: US 2015/0077670 A1
(43) Pub. Date: Mar. 19, 2015

(54) SWITCHING LENS FOR DISPLAY APPARATUS AND METHOD FOR MANUFACTURING THE SAME

(71) Applicant: KOLON INDUSTRIES, INC., Gwacheon-si (KR)

(72) Inventors: Young Kyo Son, Yongin-si (KR); Heon Seung Chae, Incheon (KR); Dong Hee Lee, Yongin-si (KR)

(73) Assignee: KOLON INDUSTRIES, INC., Gwacheon-si (KR)

(21) Appl. No.: 14/396,476

(22) PCT Filed: Jun. 10, 2013
(86) PCT No.: PCT/KR2013/005069

§ 371 Date: Oct. 23, 2014

(30) Foreign Application Priority Data
Jun. 28, 2012 (KR) 10-2012-0069575

(51) Int. Cl. B29D 11/00; G02F 1/1337; G02F 1/137; G02B 27/22

(52) U.S. Cl. CPC B29D 11/00009; G02B 27/2214; G02F 1/133788; G02F 1/133723; G02F 1/137
USPC 349/33; 349/123; 264/1.7; 264/1.36

(57) ABSTRACT

Disclosed are a switching lens and a method for manufacturing the same. The switching lens having liquid crystals of highly uniform orientation can be obtained by minimizing the thickness deviation of an alignment film formed on the whole curvature surface of a lenticular pattern. The switching lens of the present invention comprises a resin layer having a lenticular pattern and an alignment film on the resin layer. The alignment film covers the whole curvature surface of the lenticular pattern and has the maximum thickness equal to or less than 0.01 times the maximum radius of curvature of the lenticular pattern.

### TECHNICAL FIELD

The present invention relates to a switching lens for a display apparatus and a method for manufacturing the same, and more particularly, to a switching lens having liquid crystals of highly uniform orientation which can be obtained by minimizing the thickness deviation of an alignment film formed on the whole curvature surface of a lenticular pattern and a method for manufacturing the same.

### BACKGROUND ART

The principle of stereo vision with two eyes facilitates three-dimensional display of a three-dimensional image. The binocular disparity due to the two eyes which are apart from each other by about 65 mm is one of the most important factors for stereocognosy.

Once the different two-dimensional images inputted through the right and left eyes respectively are transmitted to the brain, the brain combines the images together thereby reproducing the depth and reality of the original three-dimensional image. The technology creating a three-dimensional image by means of the binocular vision is called stereography. 3D display apparatus is an apparatus to which the stereography is applied.

The 3D display apparatus may comprise a switching lens. The switching lens comprises a birefringent material (e.g., liquid crystal) whose refractive index is changeable upon the mode switching between 2D and 3D which can be performed, for example, by generating or removing electric field.

Under the 2D mode, the switching lens allows the incident light to pass through the lens without any change of its pathway. Under the 3D mode, however, the switching lens changes the pathway of the incident light to provide two different two-dimensional images to the right and left eyes respectively.

The switching lens comprises a plurality of lenticular patterns filled with the liquid crystals.

The liquid crystals within the lenticular patterns need to be exactly aligned to have a certain molecular orientation at the initial stage so that the switching lens can meet the desired optical properties.

An alignment film is generally used to set the initial molecular orientation of the liquid crystals. The alignment film is in direct contact with the liquid crystals and determines the molecular orientation of the liquid crystals. Generally, the alignment film is made by forming a film of a polymer such as polyimide and then rubbing the film with a rubbing cloth.

If a substrate on which a polymer is coated to make an alignment film has a curved shape, the polymer film formed on the substrate also has a curved shape. Such curved shape of the polymer film causes lots of problems when the rubbing process is performed.

For example, U.S. Patent Application Publication No. 2010/0181022 (hereinafter, Prior Art) says that, if a substrate on which liquid crystal molecules have to be oriented is curved, rubbing of the substrate is often irreproducible. Nevertheless, the Prior Art still suggests a method for making an alignment film by coating a polymer film on a lenticular structure and then rubbing the polymer film.

The Prior Art has lots of drawbacks as follows.

First, when a polymer solution is coated on a structure having a plurality of lenticular patterns (concave lens patterns) to form a polymer film, the polymer solution flows down along the surface of the patterns due to the gravity and gets together at the center of the each pattern. As a result, the thickness deviation of the polymer film on the curvature surface of the each lenticular pattern deviates from the acceptable range. Further, a certain portion of the curvature surface of the lenticular pattern even may not be coated with the polymer solution, which causes the defective molecular orientation of the liquid crystals.

Secondly, when the polymer film is rubbed with a rubbing cloth, a portion of the structure, especially the mountain portions between the neighboring concave lens patterns, may be damaged by the rubbing cloth thereby causing the defective molecular orientation of the liquid crystals.

### DISCLOSURE OF INVENTION

### Technical Problem

Therefore, the present invention is directed to a switching lens for a display apparatus and a method for manufacturing the same capable of preventing these limitations and drawbacks of the related art.

An aspect of the present invention is to provide a to a switching lens having liquid crystals of highly uniform orientation which can be obtained by minimizing the thickness deviation of an alignment film formed on the whole curvature surface of a lenticular pattern.

Another aspect of the present invention is to provide a method for manufacturing to a switching lens having liquid crystals of highly uniform orientation which can be obtained by minimizing the thickness deviation of an alignment film formed on the whole curvature surface of a lenticular pattern.

Additional aspects and features of the present invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims.

### Solution to Problem

In accordance with the one aspect of the present invention, there is provided a switching lens for a display apparatus, the switching lens comprising a first film, a resin layer on the first film, the resin layer comprising a lenticular pattern, a first alignment film on the resin layer, a second film, a second alignment film on the second film, and liquid crystals between the first and second alignment films, wherein the first alignment film is a photo-alignment film comprising a photosensitive polymer, the first alignment film covers whole curvature surface of the lenticular pattern of the resin layer, and the first alignment film has a maximum thickness equal to or less than 0.01 times a maximum radius of curvature of the lenticular pattern.

In accordance with another aspect of the present invention, there is provided a method for manufacturing a method for manufacturing a switching lens for a display apparatus, the method comprising preparing an upper plate, preparing a lower plate, and bonding the upper and lower plates, wherein the preparing the upper plate comprises forming a resin layer on a first film, processing a surface of the resin layer such that the resin layer has a lenticular pattern, forming a first alignment film with a photosensitive polymer on the resin layer in such a way that the first alignment film covers whole curvature surface of the lenticular pattern of the resin layer and the first alignment film has a maximum thickness equal to or less than 0.01 times a maximum radius of curvature of the lenticular pattern, and dispensing liquid crystals on the first alignment film, wherein the preparing the lower plate comprises forming a second alignment film on a second film, and wherein the upper and lower plates are bonded to each other in such a way that the second alignment film directly contacts the liquid crystals.

It is to be understood that both the foregoing general description and the following detailed description of the present invention are exemplary and explanatory and are intended to provide further explanation of the invention as claimed.

### Advantageous Effects of Invention

According to the present invention, the thickness deviation of an alignment film formed on the whole curvature surface of each lenticular pattern within a switching lens can be minimized, and thus the molecular orientation uniformity of the liquid crystals dispensed onto the alignment film can be maximized. As a result, the switching lens of the present invention can have the desired optical properties.

Other advantages of the present invention will be described below in detail together with the related technical features.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 and FIG. 2 are cross-sectional views respectively illustrating 2D mode state and 3D mode state of a display apparatus comprising a switching lens according to the first embodiment of the present invention;

FIG. 3 is a cross-sectional view of an alignment film which is formed on a lenticular pattern according to an embodiment of the present invention;

FIG. 4 and FIG. 5 are cross-sectional views respectively showing 2D mode state and 3D mode state of a display apparatus comprising a switching lens according to the second embodiment of the present invention; and

FIG. 6 schematically shows an apparatus for manufacturing a switching lens according to an embodiment of the present invention.

### MODE FOR THE INVENTION

Reference will now be made in detail to the exemplary embodiments of the present invention, examples of which are illustrated in the accompanying drawings. Wherever possible, the same reference numbers will be used throughout the drawings to refer to the same or like parts.

For the following description of the embodiments of the present invention, if a first structure is described as being formed (or disposed) on a second structure, the first and second structures may be in contact with each other, or there may be an additional structure(s) interposed between the first and second structures. However, if the first structure is described as being formed (or disposed) right on the second structure, it is limited to the case where the first and second structures are in contact with other.

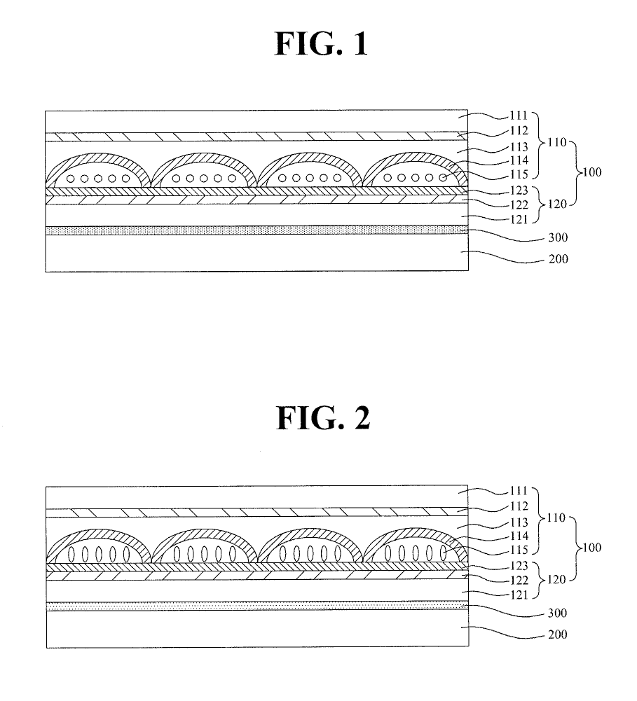

Hereinafter, a switching lens according to the first embodiment of the present invention will be described in detail with reference to the FIGS. 1 to 3.

FIG. 1 and FIG. 2 are cross-sectional views respectively illustrating 2D mode state and 3D mode state of a display apparatus comprising a switching lens according to the first embodiment of the present invention.

As illustrated in FIG. 1 and FIG. 2, the display apparatus comprises a switching lens 100 according to the first embodiment of the present invention, a display panel 200, and an adhesive layer 300 between the switching lens 100 and display panel 200.

The switching lens 100 comprises an upper plate 110 and a lower plate 120, the upper and lower plates 110 and 120 being bonded together.

The upper plate 110 comprises a first film 111, a first transparent electrode 112 on the first film 111, a resin layer 113 on the first transparent electrode 112, a first alignment film 114 on the resin layer 113, and liquid crystals 115 on the first alignment film 114.

The resin layer 113 has a plurality of lenticular patterns. The lenticular patterns may be cylindrical lens patterns. The first alignment film 114 is a photo-alignment film comprising a photosensitive polymer.

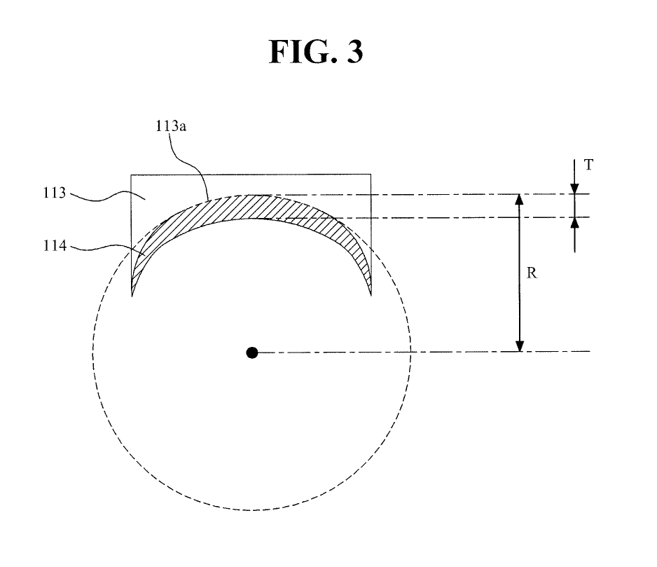

As illustrated in FIG. 3, the first alignment film 114 covers whole curvature surface 113a of the each lenticular pattern of the resin layer 113, and the first alignment film 114 has a maximum thickness T equal to or less than 0.01 times a maximum radius of curvature R of the lenticular pattern. In other words, according to the embodiment of the present invention, the first alignment layer 114 is formed on the resin layer 113 to have uniform thickness over the whole curvature surface 113a of the lenticular patterns, and thus the uniformity of the initial molecular orientation of the liquid crystals 115 whose molecular orientation is determined by, at least in part, the first alignment film 114 can be improved. Consequently, the switching lens 100 of the embodiment of the present invention can satisfy the optical properties required in the field of the three-dimensional display apparatus.

The lower plate 120 comprises a second film 121, a second transparent electrode 122 on the second film 121, and a second alignment film 123 on the second transparent electrode 122.

The upper and lower plates 110 and 120 are bonded to each other through a laminating process in such a way that the liquid crystals 115 of the upper plate 110 directly contacts the second alignment film 123 of the lower plate 120.

The initial molecular orientation of the liquid crystals 115 disposed between the first and second alignment films 114 and 123 is determined as shown in FIG. 1 by the first and second alignment films 114 and 123. As an electric field is generated between the first and second transparent electrodes 112 and 122, the molecular orientation of the liquid crystals 115 is changed into the state as illustrated in FIG. 2, and thus the refractive index of the liquid crystals 115 is changed. For example, a switching to 3D mode can be performed by generating electric field between the first and second transparent electrodes 112 and 122.

Under the 2D mode, the switching lens 100 of the embodiment of the present invention allows the incident light to pass through the lens 100 without any change of its pathway. Under the 3D mode, however, the switching lens 100 changes the pathway of the incident light to provide two different two-dimensional images to the right and left eyes respectively.

The display panel 200 is a panel including, but not limited to, a PDP panel, a LCD panel, and an OLED panel, which provides 2D image under 2D mode and 3D image (i.e., left image and right image) under 3D mode.

The adhesive layer 300 for bonding the switching lens 100 and display panel 200 together may be formed of a transparent pressure-sensitive adhesive.

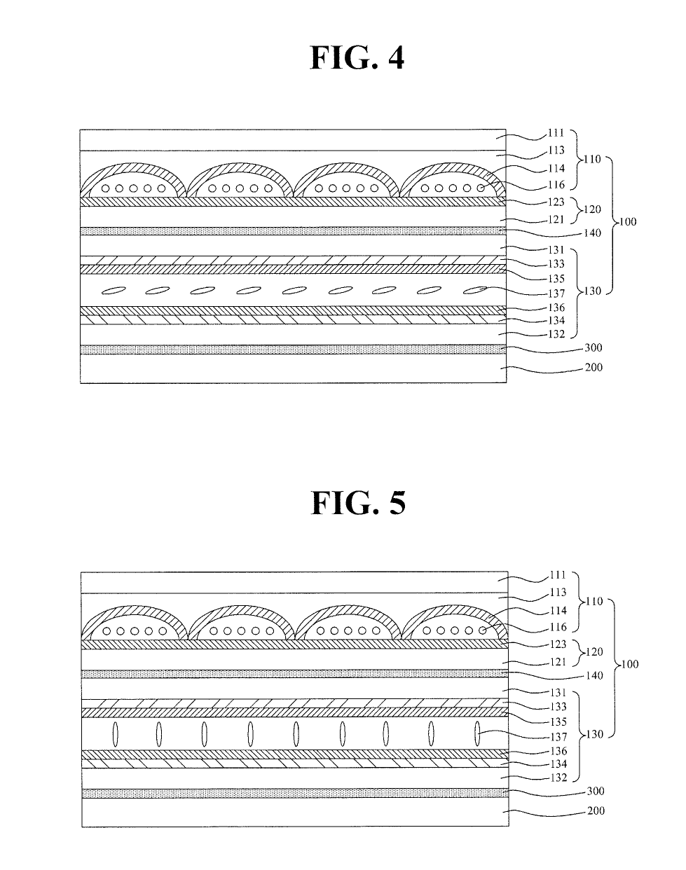

Hereinafter, a switching lens according to the second embodiment of the present invention will be described in detail with reference to the FIGS. 4 and 5. The same reference numerals as those of the first embodiment of the present invention will be used to refer to the same or like parts.

FIG. 4 and FIG. 5 are cross-sectional views respectively illustrating 2D mode state and 3D mode state of a display apparatus comprising a switching lens according to the second embodiment of the present invention.

As illustrated in FIG. 4 and FIG. 5, the display apparatus comprises a switching lens 100 according to the second embodiment of the present invention, a display panel 200, and an adhesive layer 300 between the switching lens 100 and display panel 200.

The switching lens 100 comprises an upper plate 110, a lower plate 120 bonded to the upper plate 110, a polarization switching unit 130, and an adhesive layer 140 between the lower plate 120 and the polarization switching unit 130.

The upper plate 110 comprises a first film 111, a resin layer 113 on the first film 111, a first alignment film 114 on the resin layer 113, and cured reactive mesogens 116 on the first alignment film 114.

The resin layer 113 has a plurality of lenticular patterns. The lenticular patterns may be cylindrical lens patterns. The first alignment film 114 is a photo-alignment film comprising a photosensitive polymer.

As illustrated in FIG. 3, the first alignment film 114 covers whole curvature surface 113a of the each lenticular pattern of the resin layer 113, and the first alignment film 114 has a maximum thickness T equal to or less than 0.01 times a maximum radius of curvature R of the lenticular pattern. In other words, according to the embodiment of the present invention, the first alignment layer 114 is formed on the resin layer 113 to have uniform thickness over the whole curvature surface 113a of the lenticular patterns, and thus the uniformity of the orientation of the cured reactive mesogens 116 can be improved. Consequently, the switching lens 100 of the second embodiment of the present invention can satisfy the optical properties required in the field of the three-dimensional display apparatus.

The lower plate 120 comprises a second film 121 and a second alignment film 123 on the second film 121.

The upper and lower plates 110 and 120 are bonded to each other through a laminating process in such a way that the cured reactive mesogens 116 of the upper plate 110 directly contacts the second alignment film 123 of the lower plate 120.

The polarization switching unit 130 bonded to the lower plate 120 through the adhesive layer 140 comprises third and fourth films 131 and 132, first and second transparent electrodes 133 and 134 formed on the third and fourth films 131 and 132 respectively, third and fourth alignment films 135 and 136 formed on the first and second transparent electrodes 133 and 134 respectively, and liquid crystals 137 between the third and fourth alignment films 135 and 136.

The initial molecular orientation of the liquid crystals 137 disposed between the third and fourth alignment films 135 and 136 is determined as shown in FIG. 4 by the third and fourth alignment films 135 and 136. As an electric field is generated between the first and second transparent electrodes 133 and 134, the molecular orientation of the liquid crystals 137 is changed into the state as illustrated in FIG. 5, and thus the polarization direction of the light is changed when it passes through the polarization switching unit 130.

The polarization direction of the light which passed through the polarization switching unit 130 while no electric field was applied between the first and second transparent electrodes 133 and 134 is different from that of the light which passed through the polarization switching unit 130 while a certain electric field was applied between the first and second transparent electrodes 133 and 134. The cured reactive mesogens 116 have different refractive indexes with respect to the lights of different polarization directions.

Consequently, under the 2D mode, the switching lens 100 of the second embodiment of the present invention allows the incident light to pass through the lens 100 without any change of its pathway. Under the 3D mode, however, the switching lens 100 changes the pathway of the incident light to provide two different two-dimensional images to the right and left eyes respectively.

For example, a switching to 3D mode can be performed by generating electric field between the first and second transparent electrodes 133 and 134.

The display panel 200 is a panel including, but not limited to, a PDP panel, a LCD panel, and an OLED panel, which provides 2D image under 2D mode and 3D image (i.e., left image and right image) under 3D mode.

The adhesive layer 300 for bonding the switching lens 100 and display panel 200 together may be formed of a transparent pressure-sensitive adhesive.

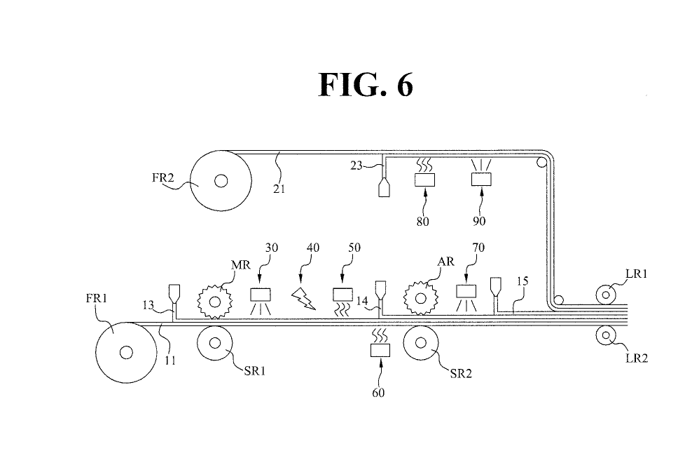

Hereinafter, a method for manufacturing a switching lens according to the embodiments of the present invention will be described in detail with reference to the FIG. 6.

FIG. 6 schematically shows an apparatus for manufacturing a switching lens according to an embodiment of the present invention.

The method for manufacturing a switching lens according to the embodiments of the present invention comprises preparing an upper plate, preparing a lower plate, and bonding the upper and lower plates together.

The step of preparing the upper plate comprises forming a resin layer on a first film 11, processing a surface of the resin layer such that the resin layer has a lenticular pattern, forming a first alignment film with a photosensitive polymer on the resin layer in such a way that the first alignment film covers whole curvature surface of the lenticular pattern of the resin layer, and dispensing liquid crystals on the first alignment film.

More specifically, the first film 11 is supplied from the first feeding roll FR1. The first film 11 used for manufacturing a switching lens described above as the first embodiment of the present invention comprises a base film and a transparent electrode. On the other hand, the first film 11 used for manufacturing a switching lens described above as the second embodiment of the present invention consists only of a base film.

A resin 13 is coated on the first film 11 supplied from the first feeding roll FR1 to form the resin layer on the first film 11. Optionally, surface modification of the first film 11 and/or cleaning thereof can be performed before the resin 13 is coated thereon.

Then, the surface of the resin layer is processed by the master roll MR while the first film 11 is supported by the supporting roll SR1 such that the resin layer has a plurality of lenticular patterns at its surface, and the resin layer having the lenticular patterns is cured at the UV curing section 30. The master roll MR may have cylindrical convex lens patterns.

Subsequently, a solution 14 comprising a photosensitive polymer is coated on the resin layer having the lenticular patterns at its surface, dried at the drying section 60, and then irradiated with a light, e.g., polarized UV, at the polarized UV irradiating section 70 to complete the first alignment film.

The solution 14 may further comprise an initiator and/or a coupling agent in addition to the photosensitive polymer, and may have viscosity of 1 to 3 cps. According to the one embodiment of the present invention, the solution 14 comprises solid components (solute) of 1 to 5 wt % and solvent of 95 to 99 wt %. The photosensitive polymer may be PI, PMMA, PVA, PNB, or copolymer thereof, which has at least one photosensitive functional group selected from the group consisting of azobenzene, cinamoyl, cumarine, chalcone, and polyimide C—N.

The solution 14 may be coated on the resin layer by means of slot die coating method, spray coating method, bar coating method, dipping method, and so on.

The process for drying the solution 14 may be performed at 90 to 110° C. for 1 to 2 minutes, and the polarized UV with which the dried solution 14 is irradiated may have wavelength of about 313 nm and energy density of several or several tens of mJ/cm².

According to the embodiment of the present invention, the first alignment film can be formed on the resin layer having the lenticular patterns without the rubbing process, and thus the risk that some portions of the resin layer, especially the mountain portions between the neighboring concave lens patterns, will be damaged by the rubbing cloth can be thoroughly removed.

Meanwhile, there exists a risk that the solution 14 will flow down along the surfaces of the plurality of lenticular patterns (i.e., concave lens patterns) due to the gravity when coated on the resin layer having the patterns. Such risk might cause the thickness deviation of the alignment film on the curvature surfaces of the lenticular patterns to deviate from the acceptable range, and further cause a certain portion of the curvature surface of the lenticular pattern even not to be covered with alignment film.

According to the embodiment of the present invention, the solution 14 coated on the resin layer is prevented or restrained as much as possible from flowing down due to the gravity so that the first alignment film formed on the resin layer can cover the whole curvature surfaces of the lenticular patterns of the resin layer and have a maximum thickness equal to or less than 0.01 times a maximum radius of curvature of the lenticular pattern.

Hereinafter, the methods according to the embodiments of the present invention to prevent or restrain the solution 14 coated on the resin layer from flowing down due to the gravity will be described in detail.

First, the resin layer the surface of which has been processed to form the lenticular patterns may be preheated at the heating section 50 before the solution 14 comprising a photosensitive polymer is coated on the resin layer. When the solution 14 is coated on the preheated resin layer of relatively high temperature, the solution 14 gets to be dried right after it becomes in contact with the preheated resin layer. Consequently, the solution 14 coated on the resin layer can be prevented or restrained as much as possible from flowing down due to the gravity.

Secondly, the step of coating the solution 14 and the step of drying the solution 14 may be performed at least in part simultaneously. In this case, the step of drying the solution 14 may be performed by supplying the hot air from the drying section 60 toward the backside of the first film 11 so that the drying step does not affect the coating step.

Thirdly, before the solution 14 being irradiated with the polarized UV after dried, the position of the solution 14 may be adjusted by means of an adjusting roll AR having a plurality of convex lens patterns of the same shape and size as those of the convex lens patterns of the master roll MR used to process the surface of the resin layer to form the lenticular patterns. In case the solution 14 falls down along the curvature surface of the lenticular pattern to a certain degree, the adjustment of the position of the solution 14 with the adjusting roll AR can restore the solution 14 to the original position thereby improving the thickness uniformity of the first alignment film. When the adjustment of the position of the solution 14 with the adjusting roll AR is performed, the first film 11 may be supported by the supporting roll SR2. Optionally, the supporting roll SR2 may be heated so that the step of adjusting the position of the solution 14 can be performed simultaneously with the step of drying the solution 14.

Fourthly, before the solution 14 is coated on the resin layer, the surface of the resin layer having the lenticular patterns, i.e., the curvature surface of the lenticular patterns, may be treated with plasma at the surface treatment section 40 so that the solution 14 can be mechanically/physically prevented from falling down due to the gravity after coated.

Each of the aforementioned methods can be used singly or in combination with other(s) to form the first alignment film which covers the whole curvature surface of the lenticular patterns of the resin layer and has the maximum thickness equal to or less than 0.01 times a maximum radius of curvature of the lenticular patterns.

After the first alignment film is completed through the polarized UV irradiation, liquid crystals are dispensed thereon. The liquid crystals 15 of the switching lens according to the first embodiment of the present invention as described above are conventional liquid crystals the molecular orientation of which is changeable by the electric field applied thereto. On the other hand, the liquid crystals 15 of the switching lens according to the second embodiment of the present invention are reactive mesogens the molecular orientation of which is set in a certain direction at the initial alignment stage and then fixed through the subsequent curing process.

Meanwhile, the step of preparing the lower plate comprises forming the second alignment film on the second film 21.

More specifically, the second film 21 is supplied from the second feeding roll FR2.

The second film 21 of the switching lens according to the first embodiment of the present invention as described above comprises a base film and a transparent electrode. On the other hand, the second film 21 of the switching lens according to the second embodiment of the present invention comprises only a base film.

A solution 23 comprising a photosensitive polymer is coated on the second film 21 and dried at the drying section 80. Subsequently, the dried solution 23 is irradiated with polarized UV at the polarized UV irradiating section 90 to complete the second alignment film.

Optionally, the second alignment film may be formed through a rubbing process since it is formed on the plane surface of the second film 21. That is, to form the second alignment film, a solution 23 comprising a polymer such as PI may be coated on the second film 21, dried at the drying section 80, and then rubbed with a rubbing cloth.

Once the upper and lower plates are prepared, they are bonded to each other by means of the first and second laminating rolls LR1 and LR2. Through the bonding process, the liquid crystals become in contact with the second alignment film.

The method for manufacturing the switching lens according to the first embodiment of the present invention further comprises performing a sealing process after the laminating process (i.e., bonding process) so that any leakage of the liquid crystals 15 can be prevented.

On the other hand, the method for manufacturing the switching lens according to the second embodiment of the present invention further comprises curing the reactive mesogens 15 after the laminating process, and then bonding the polarization switching unit to the lower plate with an adhesive. The step of curing the reactive mesogens may be performed by means of a light such as UV.

Those skilled in the art will appreciate that various modifications, additions and substitutions are possible, without departing from the scope and spirit of the invention. Accordingly, the present invention includes all alternations and modifications that fall within the scope of inventions described in claims and equivalents thereto.

1. A switching lens for a display apparatus, the switching lens comprising:
a first film;
a resin layer on the first film, the resin layer comprising a lenticular pattern;
a first alignment film on the resin layer;
a second film;
a second alignment film on the second film; and
liquid crystals between the first and second alignment films, wherein the first alignment film is a photo-alignment film comprising a photosensitive polymer,
the first alignment film covers whole curvature surface of the lenticular pattern of the resin layer, and
the first alignment film has a maximum thickness equal to or less than 0.01 times a maximum radius of curvature of the lenticular pattern.

2. The switching lens of claim 1, further comprising:
a first transparent electrode between the first film and the resin layer; and
a second transparent electrode between the second film and the second alignment film,
wherein molecular orientation of the liquid crystals is changeable by an electric field generated between the first and second transparent electrodes.

3. A method for manufacturing a switching lens for a display apparatus, the method comprising:
preparing an upper plate;
preparing a lower plate; and
bonding the upper and lower plates,
wherein the preparing the upper plate comprises:
forming a resin layer on a first film;
processing a surface of the resin layer such that the resin layer has a lenticular pattern;
forming a first alignment film with a photosensitive polymer on the resin layer in such a way that the first alignment film covers whole curvature surface of the lenticular pattern of the resin layer and the first alignment film has a maximum thickness equal to or less than 0.01 times a maximum radius of curvature of the lenticular pattern; and
dispensing liquid crystals on the first alignment film, wherein the preparing the lower plate comprises forming a second alignment film on a second film, and
wherein the upper and lower plates are bonded to each other in such a way that the second alignment film directly contacts the liquid crystals.

4. The method of claim 3, wherein the forming the first alignment film comprises:
preheating the resin layer having the lenticular pattern;
coating a solution comprising the photosensitive polymer on the preheated resin layer;
drying the solution; and
irradiating the dried solution with a light.

5. The method of claim 4, wherein the coating the solution and the drying the solution are performed simultaneously.

6. The method of claim 4, further comprising treating the surface of the resin layer having the lenticular pattern with plasma before the preheating the resin layer.

7. The method of claim 4, wherein the processing the surface of the resin layer is performed by means of a master roll having a convex lens pattern, and
the forming the first alignment film further comprises adjusting a position of the solution by means of an adjusting roll having a convex lens pattern of the same shape and size as those of the convex lens pattern of the master roll.

8. The method of claim 7, wherein the drying the solution and the adjusting the position of the solution are performed simultaneously.

9. The method of claim 7, further comprising treating the surface of the resin layer having the lenticular pattern with plasma before the preheating the resin layer.

10. The method of claim 3, wherein the processing the surface of the resin layer is performed by means of a master roll having a convex lens pattern, and
the forming the first alignment film comprises:
coating a solution comprising the photosensitive polymer on the resin layer;
adjusting a position of the solution by means of an adjusting roll having a convex lens pattern of the same shape and size as those of the convex lens pattern of the master roll;
drying the solution; and
irradiating the photosensitive polymer with a light.

11. The method of claim 3, wherein the forming the first alignment film comprises:
treating the surface of the resin layer having the lenticular pattern with plasma;
coating a solution comprising the photosensitive polymer on the resin layer treated with plasma;
drying the solution; and
irradiating the photosensitive polymer with a light.
